(19) United States
(12) Patent Application Publication
(10) Pub. No.: US 2007/0074248 A1
(43) Pub. Date: Mar. 29, 2007

(54) Remote controller for portable digital broadcasting receiver

(75) Inventor: Joung-youl Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/526,679

(22) Filed: Sep. 26, 2006

(30) Foreign Application Priority Data
Sep. 26, 2005 (KR) 2005-89520

(51) Int. Cl. H04N 5/445; H04N 5/44

(52) U.S. Cl. 725/38; 348/734

(57) ABSTRACT

A remote controller for a portable digital broadcasting receiver, the remote controller including an input unit, a search unit, and a display unit wherein the remote controller connects to the portable digital broadcasting receiver in a wired or wireless manner for remotely controlling the portable digital broadcasting receiver., The remote controller receives a search command to search for at least one channel among digital broadcasting channels received by the portable digital broadcasting receiver, searches for a list of the channels using electronic program guide (EPG) data stored in a storage device included in the portable digital broadcasting receiver, and displays information about a current operation mode of the portable digital broadcasting receiver and displays a list of the channels.

### CROSS-REFERENCE TO RELATED APPLICATION

This application claims priority from Korean Patent Application No. 2005-89520 filed on Sep. 26, 2005 in the Korean Intellectual Property Office, the disclosure of which is incorporated herein by reference in its entirety.

### BACKGROUND OF THE INVENTION

1. Field of the Invention

Aspects of the present invention relate to a remote controller for a portable digital broadcasting receiver, and more particularly, to a remote controller for a portable digital broadcasting receiver that is wiredly or wirelessly connected to the portable digital broadcasting receiver, such as, although not limited to, a digital multimedia broadcasting (DMB) receiver or a digital video broadcasting-handheld (DVB-H) receiver mounted on a portable multimedia player (PMP), a personal digital assistant (PDA), or a portable telephone, although not limited thereto, thereby enabling users to easily view or listen to various multimedia broadcasting services through digital broadcasting channels by remotely controlling the portable digital broadcasting receiver and facilitating searching for digital broadcasting channels.

Furthermore, aspects of the present invention relate to a remote controller connectable to a portable digital broadcasting receiver capable of receiving data from existing or future digital broadcasting systems and applicable to any digital broadcasting standard regardless of the method used for digital broadcasting.

2. Description of the Related Art

Examples of two common types of digital broadcasting standards are a digital multimedia broadcasting (DMB) standard and a digital video broadcasting-handheld (DVB-H) standard. The DVB-H standard was established in Europe to improve the reception rate of terrestrial digital television (DTV) during movement. The DMB standard is a new concept in a mobile multimedia broadcasting service that combines broadcasting and communication. DMB is classified into terrestrial DMB and satellite DMB based on a transmission method and a network configuration. DMB can provide audio quality equivalent to a compact disc (CD) and a data service, and can allow a user on the move to view multi-channel multimedia broadcasting through a cellular phone, a personal digital assistant (PDA), or a vehicle broadcasting receiver.

For convenience of explanation, the receipt of broadcasting content based on the DMB standard, which is widely known as a representative digital broadcasting standard, will be taken as an example. The DMB standard can be generally classified into terrestrial DMB and satellite DMB. Terrestrial DMB uses Eureka-147, a European digital audio broadcasting (DAB) standard, as a basic standard. Terrestrial DMB offers mobile multimedia broadcasting using a channel VHF 12. The terrestrial DMB service splits one channel into three blocks and several video and audio channels are generated for each block. Terrestrial DMB uses a frequency of 174-216 MHz and moving picture experts group (MPEG)-4 and H.264 for compression. In terrestrial DMB, electric waves are diffracted to be suitable for long-distance transmission. Terrestrial DMB aims at a broadcasting service for vehicle users. On the other hand, satellite DMB provides a broadcasting service using a satellite, unlike terrestrial DMB. Thus, in a downtown area having a low broadcasting reception rate, for example, broadcasting is received using a repeater called a gap filler. Satellite DMB uses a frequency higher than 2.605 GHz and the same compression method as terrestrial DMB.

The DMB standard can also be classified into two types depending on the position of a DMB receiver, i.e., an embedded DMB receiver type having a DMB receiver embedded in a DMB main body and an external DMB receiver type in which an external DMB receiver is connected to the DMB main body that does not support DMB and outputs a broadcasting to the DMB main body.

A digital broadcasting receiving platform based on, for example, a portable multimedia player (PMP) or a PDA is generally carried on the person of a user so the user can watch the broadcasting. For example, the user may carry the digital broadcasting receiving platform in his/her bag when not watching the broadcasting. On the DMB receiver, to watch a desired broadcasting program or know which program is being broadcasted, the user may have to, for example, open his/her bag, turn on the main power of a display device, and search for currently broadcasted channels. In other words, the user frequently must take the DMB receiver out of a place where it is stowed, such as a bag, turn on the main power, and search for currently broadcasted channels, even while on the move or riding on public transport.

Moreover, since the search is made after the main power of the display device of the PMP or the PDA is turned on, a large amount of power is required to drive the display of the platform and the entire system.

### SUMMARY OF THE INVENTION

Aspects of the present invention provide a remote controller having an earphone function for a portable digital broadcasting receiver, in which currently available digital broadcasting channels can be searched for by using a display screen of the remote controller that is wiredly or wirelessly connected to the portable digital broadcasting receiver, without turning on the main power of a display device of the portable digital broadcasting receiver, and a user can search for currently available digital broadcasting channels while listening to music through a digital broadcasting receiver supporting MP3 playback.

According to an aspect of the present invention, there is provided a remote controller connected to a portable digital broadcasting receiver in a wired or wireless manner for remotely controlling the portable digital broadcasting receiver, the remote controller including an input unit which receives a search command to search for at least one broadcasting channel among a plurality of digital broadcasting channels received by the portable digital broadcasting receiver, a search unit which searches for a list of the broadcasting channels using electronic program guide (EPG) data according to the search command, and a display unit which displays information about a current operation mode of the portable digital broadcasting receiver and displays a list of the channels found by the search unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a portable digital broadcasting receiver to which a remote controller for a portable digital broadcasting receiver according to an embodiment of the present invention is connected;

FIG. 2 illustrates a remote controller for a portable digital broadcasting receiver according to an embodiment of the present invention;

FIG. 3 illustrates a procedure of processing EPG data in a remote controller for a portable digital broadcasting receiver according to an embodiment of the present invention; and

FIG. 4 is a block diagram of a remote controller for a portable digital broadcasting receiver according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

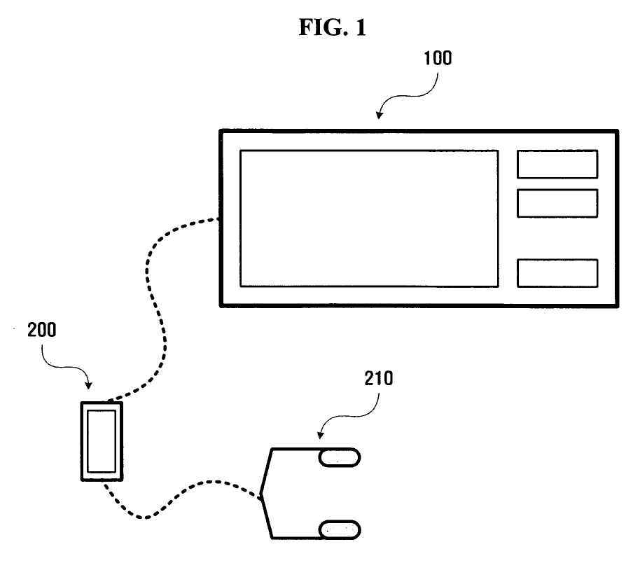

FIG. 1 illustrates a portable digital broadcasting receiver 100 to which a remote controller 200 for a portable digital broadcasting receiver according to an embodiment of the present invention is connected.

Referring to FIG. 1, the remote controller 200, according to an embodiment of the present invention, may be connected to the portable digital broadcasting receiver 100 in a wired or wireless manner. The remote controller 200 can, although not necessarily, also be connected to an earphone 210, thus allowing a user to search for digital broadcasting channels using the remote controller 200 without taking the portable digital broadcasting receiver 100 out of a stowed away location, such as a bag, or while listening to an MP3 music file in a case where the portable digital broadcasting receiver 100 supports MP3 playback. It is understood that the remote controller can be connected to the earphone or similar audio output device through a wired or wireless connection.

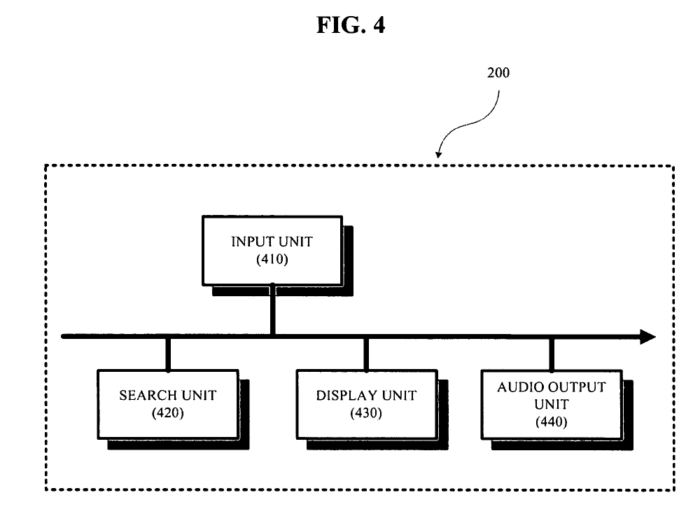

Hereinafter, the block configuration of the remote controller 200 according to an embodiment of the present invention will be described with reference to FIG. 4.

FIG. 4 is a block diagram of the remote controller 200 according to an embodiment of the present invention. Referring to FIG. 4, the remote controller 200 may, although not necessarily, include an input unit 410, a search unit 420, a display unit 430, and an audio output unit 440, although not limited thereto.

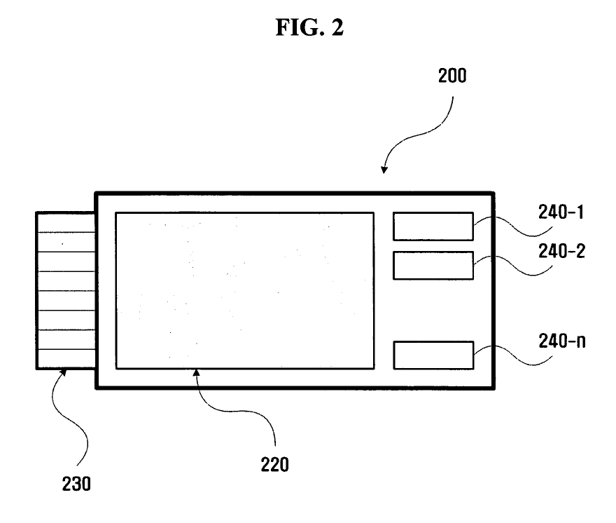

The input unit 410 receives a channel search command to search for at least one among a plurality of digital broadcasting channels received through the portable digital broadcasting receiver 100. The input unit 410 may, although not necessarily, be implemented with a jog dial 230 and/or a plurality of function buttons 240-1, 240-2, . . . , 240-n, which will be described with reference to FIG. 2. However, it is understood that the implementation of the input unit is not limited to the jog dial and/or the plurality of function buttons, and other devices, such as, although not limited to, a touch screen, may be implemented. The user inputs execution commands for various functions through the input unit 410.

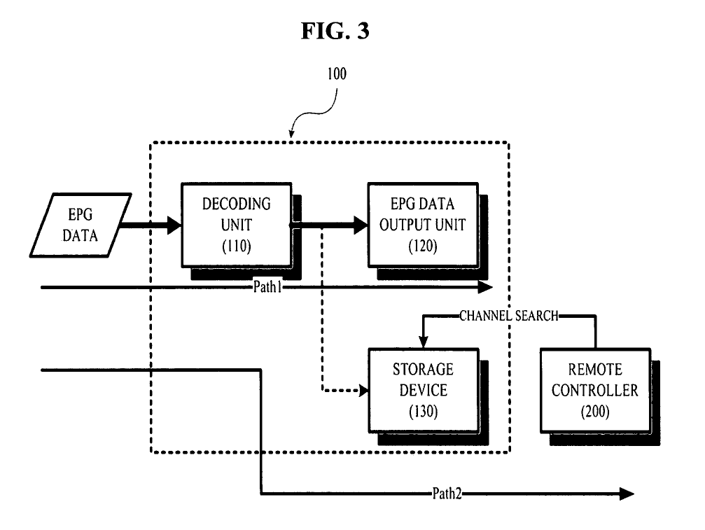

In response to the channel search command, the search unit 420 searches for a list of channels using electronic program guide (EPG) data that may, although not necessarily, be stored in a storage device included in the portable digital broadcasting receiver 100. However, it is understood that the EPG data is not necessarily stored in the storage device of the portable digital broadcasting receiver 100, and may, although not necessarily, be stored in a storage unit of the remote controller 200 or externally stored and transmitted to the portable digital broadcasting receiver 100 and/or the remote controller 200 in a broadcast signal. The search using the EPG data will be described with reference to FIG. 3.

FIG. 3 illustrates a procedure of processing EPG data in the remote controller 200 for a portable digital broadcasting receiver 100 according to an embodiment of the present invention.

An EPG is an application program used to make a program schedule table including a list of channels, programs for each channel, and a short summary of each program. The EPG data is the electronic equivalent of a printed television program guide and may be processed using a remote control device. The EPG data, which may be easily searched, includes information about received digital broadcasting and information about programs. More specifically, various information tables may be transmitted with broadcasting stream data and, once received in a separate set-top box, the broadcasting stream data is separated into pure broadcasting video information and additional data. The pure broadcasting video information is displayed on a display screen of the portable digital broadcasting receiver 100 and the additional data may be stored in a storage device, such as, although not limited to, a memory.

Two operation modes are shown in FIG. 3. A first path, labeled Path1, indicates a general digital broadcasting receiving mode in which a decoding unit 110 of the portable digital broadcasting receiver 100 decodes the EPG data and outputs the decoded EPG data to an EPG data output unit 120. In this mode, broadcasting is received after the main power of a display device of the portable digital broadcasting receiver 100 is turned on. On the other hand, a second path, labeled Path2, indicates a mode in which channels are searched for using a search function of the remote controller 200 without turning on the main power of the display screen of the portable digital broadcasting receiver 100. In this mode, data packets of the EPG data decoded by the decoding unit 110 or some of the data packets received through the portable digital broadcasting receiver 100, which contain channel information, are parsed and then stored in a storage device 130. According to a digital video broadcasting-handheld (DVB-H) standard, the EPG data may, although not necessarily, be contained in FLUTE/ALC protocols and demuxed by a receiver. Such FLUTE/ALC protocols or actual broadcasting data are executed and decoded. Once used, the EPG data may, although not necessarily, be stored in the storage device 130, such as, although not limited to, a memory. However, it is understood that the EPG data may be stored in an external storage device and accessed through a wireless or wired connection, or may be stored in a storage unit of the remote controller 200.

When the EPG data is stored in the storage device 130 of the portable digital broadcasting receiver, the remote controller 200 periodically or non-periodically receives the EPG data stored in the storage device 130 and searches for a broadcasting channel list using the EPG data. In other words, the search unit 420 receives the EPG data from the storage device 130 at predetermined time intervals or whenever the EPG data is updated, and searches for the broadcasting channel list. However, it is understood that the EPG data may be received from the storage device 130 upon a specific request transmitted from the remote controller 200. According to an aspect of the present invention, the portable digital broadcasting receiver 100 operates in a minimum operation mode in which it receives data and stores only channel information, and the predetermined time intervals may, although not necessarily, be every 15 or 10 minutes. If the EPG data is updated, the updated information may be automatically displayed on the display unit 430 of the remote controller 200. The EPG data may, although not necessarily, be received at predetermined time intervals to reduce the power needed by the display screen of the portable digital broadcasting receiver 100.

The display unit 430 may, although not necessarily, display information about a current operation mode of the portable digital broadcasting receiver 100 or the list of channels. The display unit 430 may, although not necessarily, display a list of predetermined programs to be broadcasted during a specific period, which has been preset by the user through the input unit 410. However, it is understood that the remote controller 200 does not necessarily comprise the display unit, and the remote controller 200 without the display unit can control operations of the portable digital broadcasting receiver 100 that do not require the visualizing of information.

The audio output unit 440 amplifies and outputs an audio signal from a multimedia file stored in the portable digital broadcasting receiver 100 or a broadcast channel received by the portable digital broadcasting receiver 100. If the multimedia file is a video file, the audio output unit 440 can output an audio signal, while the video file may, although not necessarily, be outputted by the portable digital broadcasting receiver 100. When the multimedia file is an audio file, the audio output unit 440 may reproduce an MP3 file and output an audio signal. However, it is understood that the audio output unit may output an audio signal of any audio file type, and is not limited to an MP3 file type. The audio output unit 440 outputs an audio signal through an output device such as, although not limited to, the earphone 210 or a headset.

The search unit 420 can search for the list of channels when the audio signal is output by the audio output unit 440. In other words, when the portable digital broadcasting receiver 100 supports an MP3, or other file type, playback function, the user can search for the list of channels through the search unit 420 while listening to an audio file, such as an MP3 file. Furthermore, the user can search for the list of channels through the search unit 420 while listening to an audio stream of a broadcast channel signal.

Hereinafter, the external configuration of the remote controller 200 according to an embodiment of the present invention will be described with reference to FIG. 2.

FIG. 2 illustrates the remote controller 200 for a portable digital broadcasting receiver 100 according to an embodiment of the present invention. A display screen 220, which may, although not necessarily, be implemented with a liquid crystal display (LCD), is provided on a surface of the remote controller 200, the plurality of function buttons 240-1, 240-2, . . . , 240-n may, although not necessarily, be included on the right side of the remote controller 200, and the jog dial 230 may, although not necessarily, be included on the left side of the remote controller 200. The function buttons 240-1, 240-2, . . . , 240-n and/or the jog dial 230 form the input unit 410. However, it is understood that the implementation of the input unit is not limited the jog dial and/or the plurality of function buttons, and other devices, such as, although not limited to, a touch screen, may be implemented.

The current operation mode of the portable digital broadcasting receiver 100, a list of currently available broadcasting channels, a list of scheduled programs, and an alarm for broadcasting a reservation set by the user may, although not necessarily and not limited thereto, be displayed on the display screen 220. In a case where the portable digital broadcasting receiver 100 supports an MP3, or other file type, playback, an MP3, or other file type, file list may be displayed on the display screen 220. In particular, the search unit 420 can facilitate a search for a currently available broadcasting channel list, a scheduled program list, or an MP3, or other file type, file list using the input unit 410 having a switching function. As shown in FIG. 2, broadcasting channels and MP3, or other file type, files stored in the portable digital broadcasting receiver 100 may, although not necessarily, be searched for by designating priorities to the search unit 420 using the function buttons 240-1, 240-2, . . . , 240-n or using the jog dial 230.

In addition, an alarm function to inform the user of a start of a preselected digital broadcasting program may be provided. The alarm function allows the user to previously set an alarm for a desired broadcasting program through the input unit 410, so that the alarm may sound at the time of or immediately prior to the start of the set broadcasting program. This alarm function sounds the alarm when the user is watching another broadcasting program or listening to an MP3, or other file type, file to inform the user of the start of the reserved broadcasting program. The alarm function may be implemented by voice or vibration, although not limited thereto.

The representative form of digital broadcasting mentioned above is DMB, i.e., broadcasting according to the DMB standard, but the present invention can also be applied to other digital broadcasting standards such as the DVB-H standard or any standard in the prior art or later developed, without being limited to DMB.

According to an aspect of the present invention, a user can conveniently search for currently available broadcasting channels using a remote controller 200 having an earphone function without turning on the main power of a display device of a digital broadcasting receiver 100, thereby saving the main power of the digital broadcasting receiver 100, increasing the use time of the receiver 100, and reducing the time required for a channel search by only searching for EPG data stored in a memory.

Moreover, the channel search can be performed by simply manipulating the remote controller 200, thereby enhancing portability of the digital broadcasting receiver 100.

In addition, the user can reserve a broadcasting program based on information displayed on a display screen 220 of the remote controller 200 and then be reliably informed of the start of the reserved broadcasting program by an alarm function for the reserved broadcasting program.

Furthermore, when the digital broadcasting receiver 100 supports MP3, or other file type, playback, the user can perform a channel search while listening to music.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A remote controller connected to a portable digital broadcasting receiver in a wired or wireless manner to remotely control the portable digital broadcasting receiver, the remote controller comprising:
an input unit to receive a search command to search for at least one broadcasting channel among a plurality of digital broadcasting channels received by the portable digital broadcasting receiver;
a search unit to search for a list of the at least one broadcasting channel among the plurality of broadcasting channels using electronic program guide (EPG) data according to the search command; and
a display unit to display the list of the at least one broadcasting channel among the plurality of broadcasting channels found by the search unit.

2. The remote controller as claimed in claim 1, further comprising an audio output unit to amplify and/or output an audio signal received from the portable digital broadcasting receiver, wherein the audio signal is generated from a multimedia file stored in the portable digital broadcasting receiver and/or the audio signal is generated from a broadcasting signal corresponding to a selected broadcasting channel and received by the portable digital broadcast receiver.

3. The remote controller as claimed in claim 2, wherein the search unit searches for the list of the at least one broadcasting channel when the multimedia file is executed and is output by the audio output unit and/or when the audio signal generated from the broadcasting signal corresponding to the selected broadcasting channel is output.

4. The remote controller as claimed in claim 2, wherein the audio output unit outputs the audio signal to earphones and/or a headset, wherein the earphones and/or the headset are connected to the remote controller in a wired or wireless connection.

5. The remote controller as claimed in claim 1, wherein the EPG data is stored in a storage device included in the portable digital broadcasting receiver and the search unit receives the EPG data from the storage device.

6. The remote controller as claimed in claim 5, wherein the search unit searches for the list of the at least one broadcasting channel among the plurality of broadcasting channels after receiving the EPG data from the storage device, wherein the search unit receives the EPG data at predetermined time intervals and/or whenever the EPG data is updated.

7. The remote controller as claimed in claim 1, further comprising a storage unit, wherein the storage unit stores the EPG data.

8. The remote controller as claimed in claim 1, wherein the EPG data is stored externally and transmitted to the portable digital broadcasting receiver and/or the remote controller through a wireless connection.

9. The remote controller as claimed in claim 1, wherein the display unit displays a list of programs to be broadcasted for a specific period, wherein the specific period is set by a user.

10. The remote controller as claimed in claim 1, wherein the display unit displays information about a current operation mode of the portable digital broadcasting receiver.

11. The remote controller as claimed in claim 1, further comprising a jog dial and/or a plurality of function buttons, wherein a manipulation of the jog dial and/or the plurality of function buttons implements the input unit and controls an operation of the remote controller.

12. The remote controller as claimed in claim 1, wherein the display device comprises a touch screen, wherein a manipulation of the touch screen implements the input unit and controls an operation of the remote controller.

13. The remote controller as claimed in claim 1, further comprising an alarm function to inform a user of a start of a preselected digital broadcasting program.

14. A method of remotely controlling a portable digital broadcasting receiver, the method comprising:
connecting a remote controller to the portable digital broadcasting receiver using a wired or wireless connection;
receiving a search command in the remote controller to search for at least one broadcasting channel among a plurality of digital broadcasting channels received by the portable digital broadcasting receiver;
searching for a list of the at least one broadcasting channel among the plurality of broadcasting channels using EPG data according to the search command; and
displaying the list of the at least one broadcasting channel among the plurality of broadcasting channels found by the searching for the list.

15. The method as claimed in claim 14, further comprising:
selecting a broadcasting channel from the list of the at least one broadcasting channel;
receiving a broadcasting signal of the selected broadcasting channel from the portable digital broadcasting receiver; and
outputting an audio signal of the received broadcasting signal from the portable digital broadcasting receiver through an output of the remote controller.

16. The method as claimed in claim 14, wherein the searching for the list comprises receiving the EPG data from a storage unit of the portable digital broadcasting receiver at predetermined time intervals and/or whenever the EPG data is updated.

17. A remote controller connected to a portable digital broadcasting receiver in a wired or wireless manner to remotely control the portable digital broadcasting receiver, the remote controller comprising:
an input unit to receive a search command to search for at least one broadcasting channel among a plurality of digital broadcasting channels received by the portable digital broadcasting receiver; and
a search unit to search for a list of the at least one broadcasting channel among the plurality of broadcasting channels using electronic program guide (EPG) data according to the search command.

18. The remote controller as claimed in claim 17, further comprising a display unit to display the list of the at least one broadcasting channel among the plurality of broadcasting channels found by the search unit.

19. The remote controller as claimed in claim 17, further comprising an audio output unit to amplify and/or output an audio signal received from the portable digital broadcasting receiver, wherein the audio signal is generated from a multimedia file stored in the portable digital broadcasting receiver and/or the audio signal is generated from a broadcasting signal corresponding to a selected broadcasting channel and received by the portable digital broadcast receiver.

20. The remote controller as claimed in claim 19, wherein the search unit searches for the list of the at least one broadcasting channel when the multimedia file is executed and is output by the audio output unit and/or when the audio signal generated from the broadcasting signal corresponding to the selected broadcasting channel is output.

21. The remote controller as claimed in claim 19, wherein the audio output unit outputs the audio signal to earphones and/or a headset, wherein the earphones and/or the headset are connected to the remote controller in a wired or wireless connection.

22. The remote controller as claimed in claim 17, wherein the EPG data is stored in a storage device included in the portable digital broadcasting receiver and the search unit receives the EPG data from the storage device.

23. The remote controller as claimed in claim 17, further comprising a jog dial and/or a plurality of function buttons, wherein a manipulation of the jog dial and/or the plurality of function buttons implements the input unit and controls an operation of the remote controller.
